(19) United States
(12) Patent Application Publication
(10) Pub. No.: US 2007/0024411 A1
(43) Pub. Date: Feb. 1, 2007

(54) Arrangement for the local monitoring of functions

(76) Inventors: Rainer Lang, Georgenberg (DE); Otto Nachbauer, Floss (DE); Michael Helgert, Freiferr-von-Lichtenstern-Strabe (DE); Richard Riedel, Floss (DE)

Correspondence Address: SOFER & HAROUN LLP., 317 MADISON AVENUE, SUITE 910, NEW YORK, NY, 10017, US

(21) Appl. No.: 11/407,388

(22) Filed: Apr. 19, 2006

(30) Foreign Application Priority Data
Aug. 1, 2005 (EP) 05291649.1

(51) Int. Cl. H01C 7/13

(52) U.S. Cl. 338/22 R

(57) ABSTRACT

A local monitoring of functions, in which a sensor is connected to a voltage source via an electrical conductor, in which the sensor is arranged, together with at least one further electrical or electronic component, on a printed circuit board (9) provided with conductor tracks, the sensor being electrically conductively connected, by means of the conductor tracks of the printed circuit board (9), to the component connected to the conductor tracks, and in which the printed circuit board (9) is arranged in a housing (15). In order to supply a secure and immovable hold, the printed circuit board (9) with conductors (7, 8) connected to the conductor tracks is arranged in a holder (17), which is made from a mechanically stable insulating material, accommodates the printed circuit board (9) and has limiting stops (19, 20, 21) for the printed circuit board (9) and laterally protruding latching elements (22, 23). The holder (17) with the printed circuit board (9) inserted is latched in the housing (15), in a prescribed position in the housing (15), by means of the latching elements (22, 23), and the housing (15) is filled with a compound (27) which surrounds the holder (17) and the printed circuit board (9) without any cavities.

### RELATED APPLICATION

This application is related to and claims the benefit of priority from European Patent Application No. 05291649.1, filed on Aug. 1, 2005, the entirety of which is incorporated herein by reference.

### FIELD OF THE INVENTION

The present invention relates to a sensor for the local monitoring of functions.

### BACKGROUND

The invention relates to an arrangement for the local monitoring of functions, in which a sensor is connected to a voltage source via an electrical conductor, in which the sensor is arranged, together with at least one further electrical or electronic component, on a printed circuit board provided with conductor tracks, said sensor being electrically conductively connected, by means of the conductor tracks of said printed circuit board, to the component which is likewise connected to the conductor tracks, and in which the printed circuit board is arranged in a housing (JP-A-62096829).

“Sensor” in the context of the invention is intended to mean a component which monitors functions at specific points in machines and devices and converts these functions into electrical variables which can be evaluated. “Functions” may in this case be, in particular, positions, rotational speeds and temperatures. Temperatures will be taken into consideration below in a representative manner for all possible functions, and the sensor will be in the form of a temperature sensor.

An arrangement having a temperature sensor is used, for example, wherever it is necessary to ensure, in the case of machines and devices having heat generators, that excessive temperatures do not occur at predetermined points. It is then possible, if appropriate, to provide cooling or the respective heat source can be brought out of operation at least for a short period of time. Using conventional technology, an NTC (negative temperature coefficient) thermistor is used, for example, as the temperature sensor, which thermistor is provided with two electrical conductors and is connected to a control unit for power supply purposes, said control unit for its part being connected to a voltage source. The temperature sensor—referred to below as “NTC” for short—is generally embedded in insulating material, for example in epoxy resin, in order to protect it. An NTC is an electrical thermistor, whose resistance value decreases as the temperature increases. The resistance value can be monitored by means of evaluation electronics provided in the control unit, by means of which evaluation electronics a measure for reducing the temperature can be initiated, if appropriate.

One use sector for such an arrangement is, for example, motor vehicles. Points at which an NTC can be arranged for the purpose of monitoring the temperature are in this case, for example, in the region of the engine or on compressors for pneumatic suspensions or in the transmission oil. The arrangements having an NTC which are available on the market and are in use in principle function in a satisfactory manner. However, it may arise that electrical voltages are induced in the conductors, with which an NTC is connected to the evaluation electronics, for example owing to external electromagnetic fields. As a result, parasitic currents flowing in the conductors may be produced, with the result that the respective NTC is not only heated owing to its environment but, in addition, is also electrically heated. The measurement result can in this case be corrupted, since the resistance value of the NTC is reduced to a value which does not correspond to the ambient temperature. Owing to excessive voltages, which may inadvertently be supplied to the NTC, it is possible for said NTC to also be destroyed. In order to achieve perfect, reproducible measurement results it is also necessary that the NTC can be mounted in a specific position in a manner which is as simple as possible, said position being kept stable even during operation of a motor vehicle or another device.

The known arrangement in accordance with JP-A-62096829 is used for monitoring the temperature of the cooling water of a machine. In this arrangement, two thermistors are arranged in addition to other components on a printed circuit board made from a ceramic material. The printed circuit board is accommodated in a metallic housing, whose end face itself is used as the temperature sensor, from which the respective temperature value is transmitted to one of the thermistors.

### OBJECTS AND SUMMARY OF THE INVENTION

The invention is based on the object of designing the arrangement described at the outset such that the NTC is protected in a simple manner against external influences and can likewise be brought into a stable position in a simple manner.

This object is achieved according to the invention by the fact that
the printed circuit board with conductors connected to the conductor tracks is arranged in a holder, which is made from a mechanically stable insulating material, accommodates said printed circuit board and has limiting stops for the printed circuit board and laterally protruding latching elements, and
the holder with the printed circuit board inserted is latched in a prescribed position in the housing by means of the latching elements, said housing being filled with a compound which surrounds the holder and the printed circuit board without any cavities.

With this arrangement, all of the components and in particular the NTC are fitted on the printed circuit board, which is mechanically stabilized in terms of its position by the holder and the surrounding compound and is accommodated in the housing in a protected manner. In this case, the printed circuit board with connected conductors in the holder provided with limiting stops is arranged in a stable position in the housing if the holder is latched into said housing in the mounted position by means of its latching elements. The compound surrounding all of the components in the housing without any cavities is used for providing additional protection for these components. Once everything has been fitted in the housing, there is then, irrespective of the number of components located therein, only one component present which can be mounted with little complexity and which maintains its mounted position in a stable manner.

As a further electrical or electronic component, a capacitor, for example, can be connected together with the NTC to the conductor tracks of the printed circuit board. Owing to the capacitor which acts as a short circuit with respect to alternating currents, the NTC is protected against currents which are produced by induction on its conductors. Its DC supply from the evaluation electronics remains unchanged. External electromagnetic fields can therefore no longer corrupt the measurement result.

In one preferred embodiment, an electrical resistor in the form of a series resistor in series with the NTC and a further electrical resistor in parallel with the NTC are also connected to the conductor tracks on the printed circuit board in addition to the NTC and the capacitor. A series resistor protects the NTC from overvoltages which may result owing to faulty switching operations if, for example, assisted starting of the associated automobile is intended to be carried out using jumper cables to a battery having too high a voltage. A resistor connected in parallel with the NTC indicates the existing connection of the NTC in an evaluation unit even at very low external temperatures of, for example, below −20° C.

### BRIEF DESCRIPTION OF THE DRAWINGS

One exemplary embodiment of the subject matter of the invention is illustrated in the drawings, in which:

FIG. 1 shows a schematic illustration of an apparatus having an arrangement fitted therein according to the invention.

FIG. 2 shows a schematic of a printed circuit board which can be used in the arrangement.

FIG. 3 shows an enlarged illustration of a holder for the printed circuit board.

FIG. 4 shows an illustration, which is reduced in size again, of a printed circuit board inserted into the holder.

FIG. 5 shows the holder with the printed circuit board in a cut-open housing.

FIG. 6 shows the housing in the closed state.

### DETAILED DESCRIPTION

In the description below, the “NTC” will continue to be explained as the sensor. For reasons of completeness, however, mention will be made of the fact that the sensor can in principle also be used, for example, for detecting positions and rotational speeds, in particular in the context of an anti-lock braking system (ABS) or an electrical braking system (EBS) or all rotating parts, for example the engine, of motor vehicles. All of the temperature sensors which can be used in the context of the invention should likewise be encompassed by the NTC. In addition, motor vehicles are mentioned as a specific use sector—in a representative manner for all other possible use sectors.

In FIG. 1, parts of a motor vehicle are indicated schematically by boxes, for example a compressor 1 for a pneumatic suspension and an engine 2. The motor vehicle also has a control unit 3, which is connected to a voltage source 4, which is generally the battery of the motor vehicle. Evaluation electronics 5 are arranged in the control unit 3.

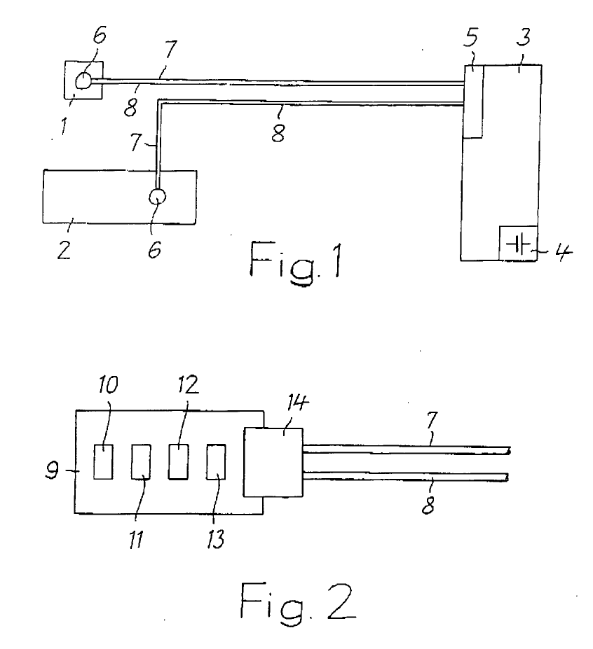

At least one arrangement 6, which comprises an NTC and at least one further electrical or electronic component, is positioned both in the region of the compressor 1 and in the region of the engine 2, for temperature monitoring purposes. Each arrangement 6 is connected to the evaluation electronics 5 via two electrical conductors 7 and 8. The arrangements 6 can also be fitted in the region of other parts of the motor vehicle for temperature monitoring purposes. The design of these arrangements 6 will be explained by way of example below with reference to FIGS. 2 to 6:

FIG. 2 shows a schematic illustration of a printed circuit board 9 which is equipped with conductor tracks and on which an NTC 10, a capacitor 11, an electrical series resistor 12 and a second electrical resistor 13 are fitted. All of the components illustrated are connected to the conductor tracks of the printed circuit board 9. The capacitor 11 and the resistor 13 in this case are connected electrically in parallel with the NTC 10, while the series resistor 12 is connected electrically in series with said NTC 10. The capacitor 11 protects the NTC 10 from high currents produced by induction, while the series resistor 12 protects said NTC 10 from overvoltages. Even at very low temperatures of below −20° C., the parallel-connected resistor 13, in the evaluation electronics 5, indicates that a functional NTC 10 is present. The conductors 7 and 8, which are connected to the evaluation electronics 5, are connected to the printed circuit board 9 or its conductor tracks via a plug connector 14.

The printed circuit board 9 is preferably made from a thermally resistant insulating material, to be precise in a preferred embodiment from ceramic. In addition to the components described, further electrical or electronic components can also be arranged on the printed circuit board 9 which may be of significance for reliable operation of the NTC 10.

The printed circuit board 9 with components arranged thereon is accommodated, in the mounted position, in a housing 15, which can be seen in FIG. 6 and which can be closed by means of a cap 16. The housing 15 is preferably made from metal, such as aluminium. However, it could also be made from a thermally resistant plastic. The cap 16 which is possibly provided is made from plastic, preferably from an elastomer.

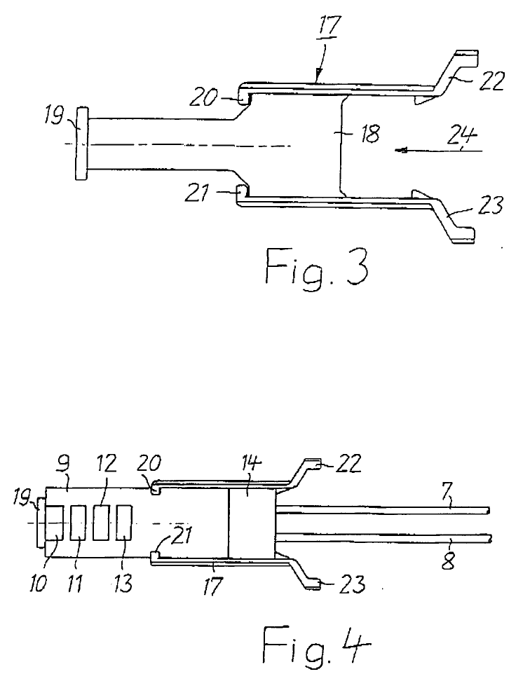

In order that the printed circuit board 9 is positioned securely and immovably in the housing 15, said printed circuit board 9 is first inserted into a holder 17 made from a mechanically stable insulating material, such as polybutylene terephthalate. The holder 17, as shown in FIG. 3, has a bearing face 18, limiting stops 19, 20 and 21 and two latching elements 22 and 23, which protrude laterally and outwards from said holder 17. In the mounted position, the printed circuit board 9 is in a position, which is limited by the stops 19, 20 and 21, on the bearing face 18 of the holder 17. The printed circuit board 9 with the plug connector 14 fitted thereon has been brought into this mounted position shown in FIG. 4 by being inserted into the holder 17 in the direction of the arrow 24.

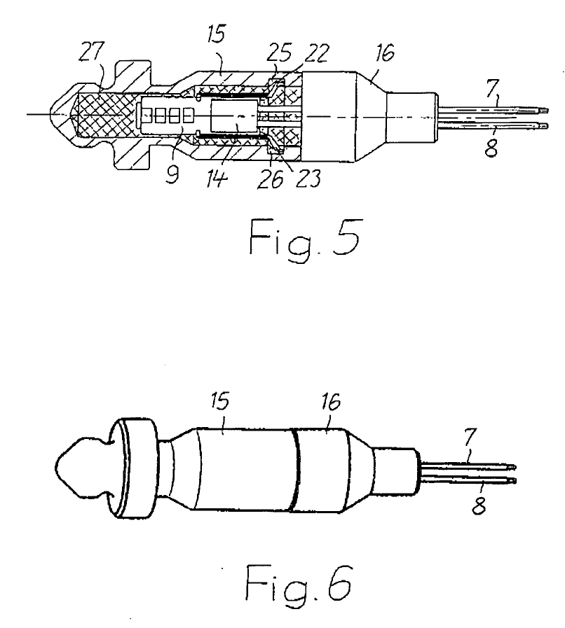

In order to complete the arrangement, the complete holder 17 is inserted into the still open housing 15 until its latching elements 22 and 23, which in the process are bent inwards, as shown in FIG. 5, latch into cutouts 25 and 26 which are provided in the interior of the housing 15. Then, a thermally resistant compound 27 is introduced into the housing 15 and surrounds the printed circuit board 9 and the holder 17 without any cavities. In order to achieve this with an increased degree of reliability, the compound 27 is possibly expediently introduced into the housing 15 before the holder 17 is inserted. The compound 27 can be based on epoxy resin, silicone or polyurethane. Finally, the housing 15 is closed, if appropriate, by means of the cap 16.

1. Arrangement for the local monitoring of functions comprising:
a sensor connected to a voltage source via an electrical conductor, in which the sensor is arranged, together with at least one further electrical or electronic component, on a printed circuit board provided with conductor tracks, said sensor being electrically conductively connected, by means of the conductor tracks of said printed circuit board, to the component connected to the conductor tracks, and in which the printed circuit board is arranged in a housing, wherein
the printed circuit board with conductors connected to the conductor tracks is arranged in a holder, which is made from a mechanically stable insulating material, accommodates said printed circuit board and has limiting stops for the printed circuit board and laterally protruding latching elements, and
wherein the holder with the printed circuit board inserted is latched in a prescribed position in the housing by means of the latching elements, said housing being filled with a compound which surrounds the holder and the printed circuit board without any cavities.

2. Arrangement according to claim 1, wherein the printed circuit board is made from a thermally resistant material.

3. Arrangement according to claim 2, wherein the printed circuit board is made from aluminium.

4. Arrangement according to claim 2, wherein the printed circuit board is made from ceramic.

5. Arrangement according to claim 1, wherein the housing is closed by means of a cap.

6. Arrangement according to claim 1, wherein the sensor is a temperature sensor.
